(19) United States
(12) Patent Application Publication
(10) Pub. No.: US 2015/0062353 A1
(43) Pub. Date: Mar. 5, 2015

(54) AUDIO VIDEO PLAYBACK SYNCHRONIZATION FOR ENCODED MEDIA

(71) Applicant: Microsoft Corporation, Redmond, WA (US)

(72) Inventors: Firoz Dalal, Sammamish, WA (US); Yongjun Wu, Bellevue, WA (US); Shyam Sadhwani, Bellevue, WA (US); Jarred Bonaparte, Seattle, WA (US)

(21) Appl. No.: 14/015,278

(22) Filed: Aug. 30, 2013

(51) Int. Cl. H04N 5/04; G11B 27/30; H04N 17/00; H04N 21/8547; H04N 21/2368; H04N 21/434

(52) U.S. Cl. CPC H04N 5/04; H04N 21/2368; H04N 21/4341; H04N 17/004; H04N 21/8547; G11B 27/3036
USPC 348/194; 348/515

(57) ABSTRACT

Techniques are described for inserting encoded markers into encoded audio-video content. For example, encoded audio-video content can be received and corresponding encoded audio and video markers can be inserted. The encoded audio and video markers can be inserted without changing the overall duration of the encoded audio and video streams and without changing most or all of the properties of the encoded audio and video streams. Corresponding encoded audio and video markers can be inserted at multiple locations (e.g., sync locations) in the encoded audio and video streams. Audio-video synchronization testing can be performed using encoded audio-video content with inserted encoded audio-video markers.

### BACKGROUND

People are increasingly using different types of devices and software applications to play multimedia content. For example, people use computing devices, such as desktop computers and mobile devices, to view movies and video clips, to download on-demand or streaming multimedia content, to record and capture audio-video content (e.g., a video chat or on-line conference), and to perform other recording and playback tasks using multimedia content.

In order for the user to have a positive experience when producing or consuming multimedia content, it is important that audio and video information in the multimedia content be synchronized. For example, if a user is watching a movie, the video content should be synchronized to the audio content (e.g., so that an actor's mouth is moving in time with the words that the actor is speaking).

However, with the increasing number of different types of software and hardware used to consume and produce multimedia content, testing for audio-video synchronization can be problematic and time consuming.

Some solutions have been developed to help test audio-video synchronization using uncompressed audio and video content. However, such solutions may only be useful in detecting synchronization problems at the encoding or authoring stage, and may not be able to detect or isolate problems at the playback stage.

Therefore, there exists ample opportunity for improvement in technologies related to testing audio-video synchronization.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for inserting encoded markers into encoded audio-video content. For example, encoded video markers can be inserted into an encoded video stream without increasing the overall duration of the encoded video stream. Furthermore, the original video stream can remain substantially unchanged, retaining all original (or nearly all original) video properties. Encoded audio markers can be inserted into an encoded audio stream (e.g., at sync locations corresponding to the inserted video markers) without increasing the overall duration of the encoded audio stream. Furthermore, the original audio stream can remain substantially unchanged, retaining all original (or nearly all original) audio properties. Audio-video synchronization testing can be performed using encoded audio-video content with inserted encoded audio-video markers.

For example, a method can be provided for inserting encoded markers into encoded audio-video content. The method comprises receiving encoded audio-video content comprising an encoded video stream and an encoded audio stream, inserting an encoded video marker into the encoded video stream at a video sync location, inserting an encoded audio marker into the encoded audio stream at an audio sync location corresponding to the video sync location, and outputting the encoded video stream with the inserted encoded video marker and the encoded audio stream with the inserted encoded audio marker. The encoded video marker can be inserted without decoding or encoding (or re-encoding) the encoded video stream, and the encoded audio marker can be inserted without decoding or encoding (or re-encoding) the encoded audio stream.

As another example, a method can be provided for inserting encoded markers into encoded audio-video content. The method comprises receiving encoded audio-video content comprising an encoded video stream and an encoded audio stream, analyzing the encoded video stream to determine video encoding parameters, encoding a video marker using, at least in part, the determined video encoding parameters to create an encoded video marker compatible with the encoded video stream, inserting the encoded video marker into the encoded video stream at a video sync location, analyzing the encoded audio stream to determine audio encoding parameters, encoding an audio marker using, at least in part, the determined audio encoding parameters to create an encoded audio marker compatible with the encoded audio stream, inserting the encoded audio marker into the encoded audio stream at an audio sync location corresponding to the video sync location, and outputting the encoded video stream with the inserted encoded video marker and the encoded audio stream with the inserted encoded audio marker. The encoded video marker can be inserted without decoding or encoding (or re-encoding) the encoded video stream, and the overall duration of the encoded video stream can remain the same after the encoded video marker is inserted. The encoded audio marker can be inserted without decoding or encoding (or re-encoding) the encoded audio stream, and the overall duration of the encoded audio stream can remain the same after the encoded audio marker is inserted.

As another example, a method can be provided for testing synchronization of encoded audio-video content. The method comprises receiving encoded audio-video content comprising an encoded video stream and an encoded audio stream, the encoded video stream comprising one or more video markers, and the encoded audio stream comprising one or more corresponding audio markers, initiating playback of the encoded audio-video content, during playback of the encoded audio-video content: capturing decoded video content (e.g., where the captured video content is captured at a reduced resolution), and capturing decoded audio content (e.g., where the captured audio content is captured with a reduced number of audio channels and/or reduced quality), from the captured video content and the captured audio content, matching the one or more video markers and the one or more corresponding audio markers, and based on the matching, outputting audio-video synchronization information.

As another example, computing devices comprising processing units and memory can be provided for performing operations described herein. For example, a computing device can receive encoded audio-video content, insert encoded audio-video markers, and output encoded audio-video content with the inserted markers (e.g., output as test audio-video content). A computing device can test audio-video synchronization by receiving encoded audio-video content with inserted markers, capturing audio-video content during playback, and matching audio-video markers to determine synchronization results.

As described herein, a variety of other features and advantages can be incorporated into the technologies as desired.

### BRIEF DESCRIPTION OF THE DRAWINGS

FIG. 1 is an example diagram depicting insertion of encoded audio-video markers into encoded audio-video streams.

FIG. 2 is an example diagram depicting insertion of encoded audio-video markers into encoded audio-video streams, including de-multiplexing and multiplexing audio content.

FIG. 3 is a flowchart of an example method for inserting encoded markers into encoded audio-video content.

FIG. 4 is a flowchart of an example method for inserting encoded video markers while maintaining the same overall duration.

FIG. 5 is a flowchart of an example method for creating encoded audio-video markers based on audio-video encoding parameters.

FIG. 6 is a prior art diagram of an example video stream and video timestamp table.

FIG. 7 is a diagram of an example video stream and video timestamp table showing an inserted encoded video marker frame.

FIG. 8 is a diagram showing example video and audio streams with inserted video and audio markers at sync locations.

FIG. 9 is a flowchart of an example method for testing synchronization of encoded audio-video content with inserted encoded audio-video markers.

FIG. 10 is a diagram of an exemplary computing system in which some described embodiments can be implemented.

FIG. 11 is an exemplary mobile device that can be used in conjunction with the technologies described herein.

FIG. 12 is an exemplary cloud-support environment that can be used in conjunction with the technologies described herein.

### DETAILED DESCRIPTION

### Example 1

### Overview

As described herein, various techniques and solutions can be applied for testing synchronization between encoded audio and encoded video streams. For example, encoded video markers can be inserted into one or more encoded video streams and encoded audio markers can be inserted into one or more encoded audio streams. Encoded video markers and encoded audio markers can be inserted at corresponding locations in audio and video streams (e.g. sync locations or sync points), such as locations with corresponding timestamps (e.g., with the same or nearly the same timestamp).

There are a number of existing solutions for testing audio-video synchronization that add detectable content to uncompressed audio and video, encode the audio and video, and then detect synchronization errors. However, such existing solutions suffer from a number of limitations. For example, access to the raw uncompressed audio and video is required, or encoded audio and video may need to be decoded and re-encoded with the inserted content (e.g., which can lose some or all of the original properties of the encoded audio and video). In addition, such existing solutions may be unable to isolate potential causes of synchronization errors (e.g., between encoding operations and playback operations).

In the techniques and solutions described herein, encoded audio-video markers can be inserted into existing encoded audio-video streams. Synchronization analysis and testing can be performed using the encoded audio-video streams with the encoded markers. For example, synchronization testing can be performed with various software and/or hardware playback systems. In this way, the end-to-end playback pipeline can be tested for synchronization issues.

In some implementations, encoded audio and video markers are inserted into encoded audio and video streams without changing the original duration or length of the encoded audio and video streams. For example, for video streams, existing video frames in encoded video streams can be reduced in duration and the marker frames can be inserted. For audio, existing audio frames can be replaced with marker frames.

In some implementations, encoded audio and video streams are analyzed to determine encoding properties. The encoding properties can be used when encoding the audio and video markers for insertion into the encoded streams to maintain compatibility and proper playback of the encoded streams.

### Example 2

### Encoded Audio-Video Content

In the technologies described herein, markers can be inserted into encoded audio-video content to test audio-video synchronization during playback. Encoded audio-video content comprises one or more video streams encoded according to one or more video codecs (e.g., according to one or more video coding standards), and one or more audio streams encoded according to one or more audio codecs (e.g., according to one or more audio coding standards). For example, an encoded video stream can be encoded according to MPEG-1/MPEG-2 coding standard, the SMPTE VC-1 coding standard, the H.264/AVC coding standard, the emerging H.265/HEVC coding standard, or according to another video coding standard. An encoded audio stream can be encoded according to the AAC coding standard, the MP3, MPEG-1, and MPEG-2 coding standard, or according to another audio coding standard.

Encoded audio-video content can be received from a variety of sources. For example, encoded audio-video content can be obtained from a file, such as from a file storing encoded audio and video streams in a digital container format. Encoded audio-video content can be received from a network streaming source, from a capture device (e.g., video and audio from a camera and microphone, which is then encoded), or from another source.

Encoded audio-video content can be received in a digital container format. The digital container format can group one or more encoded video streams and one or more encoded audio streams. The digital container format can also comprise meta-data (e.g., describing the different video and audio streams). Examples of digital container formats include MP4 (defined by the MPEG-4 standard), AVI (defined by Microsoft®), MKV (the open standard Matroska Multimedia Container format), MPEG-2 Transport Stream/Program Stream, and ASF (advanced streaming file format).

### Example 3

### Audio-Video Markers

In the technologies described herein, encoded video markers can be inserted into encoded video streams and encoded audio markers can be inserted into encoded audio streams. The encoded audio and video markers can be used to test audio-video synchronization when the encoded streams are played back (e.g., tested during playback on a variety of computing devices using a variety of playback software and/or hardware).

A video marker can be any type of marker that can later be recognized during playback (e.g., that contains video content that can later be recognized). For example, a video marker can include specific picture content (e.g., all black content, all white content, a particular pattern, etc.). A video marker can also include content that represents information, such as a frame number, a synchronization location number, a timestamp, and/or other types of information. The content of a video marker can be different from the content of a video stream into which the marker will be inserted.

A video marker can comprise one or more pictures (e.g., frames and/or fields) of video content. In a specific implementation, a single frame with black content is used as a video marker.

An audio marker can be any type of marker that can later be recognized during playback (e.g., that contains audio content that can later be recognized). For example, an audio marker can include an audible tone or chirp that can be detected later during playback. An audio marker can also include content that conveys information, such as a series of tones or frequencies, each indicating a different marker frame identifier (e.g., so that multiple audio markers in an audio frame can be distinguished from one another). The content of an audio marker can be selected so that it can be distinguished from (e.g., different than) other audio content of the audio stream.

An audio marker can comprise one or more frames of audio content. In a specific implementation, a sequence of two audio frames with an audible tone or chirp is used as an audio marker.

### Example 4

### Encoding Audio-Video Markers

In the technologies described herein, audio and video markers can be encoded and inserted into encoded audio and video streams. The encoded audio and video streams with the inserted encoded markers can be used to test audio-video synchronization when the encoded streams are played back (e.g., tested during playback on a variety of computing devices using a variety of playback software and/or hardware).

In some implementations, audio and/or video markers are encoded according to encoding parameters of encoded audio and/or video streams. For example, an encoded video stream can be analyzed to determine video encoding parameters. Video encoding parameters can include information indicating the video codec and corresponding video standard (e.g., VC-1, H.264, H.265, H.263, MPEG-1, MPEG-2, etc.) used to encode the video stream and/or other parameters used in the encoding process (e.g., bitrate, resolution, progressive or interlaced options, frame rate, aspect ratio, etc.).

Once video encoding parameters have been determined, a video marker (e.g., a single black frame) can be encoded using some or all of the determined video encoding parameters. Encoding the video marker based on the determined video encoding parameters can be used to create an encoded video marker that is compatible with the encoded video stream (e.g., that can be inserted into the encoded video stream without causing decoding or playback errors).

Similarly, an encoded audio stream can be analyzed to determine audio encoding parameters. Audio encoding parameters can include information indicating the audio codec and corresponding audio standard (e.g., AC3, E-AC3, AAC, MP3, WMA, etc.) used to encode the audio stream and/or other parameters used in the audio encoding process (e.g., bitrate, channel information, sample rate, etc.).

Once audio encoding parameters have been determined, an audio marker (e.g., a sequence of audio frames) can be encoded using some or all of the determined audio encoding parameters. Encoding the audio marker based on the determined audio encoding parameters can be used to create an encoded audio marker that is compatible with the encoded audio stream (e.g., that can be inserted into the encoded audio stream without causing decoding or playback errors).

In some implementations, audio and/or video markers are encoded based on encoding parameters determined from encoded audio and/or video streams. For example, encoded audio and/or video streams can be analyzed to determine audio and/or video encoding parameters, and based on the determined audio and/or video encoding parameters, audio and/or video markers can be encoded and inserted. In other implementations, pre-encoded audio and/or video markers are selected according to determined audio and/or video encoding parameters from analyzed encoded audio and/or video streams. For example, a collection of pre-encoded audio and/or video markers can be maintained for use with encoded audio and/or video streams using common encoding parameters.

### Example 5

### Inserting Encoded Audio-Video Markers

In the technologies described herein, encoded audio and video markers can be inserted into encoded audio and video streams. The encoded audio and video streams with the inserted encoded markers can be used to test audio-video synchronization when the encoded streams are played back. For example, the end-to-end playback path can be tested.

Encoded video markers can be inserted into encoded video streams. For example, encoded video markers can be inserted as new pictures (e.g., frames, fields, and/or slices), or the encoded video markers can be inserted by replacing existing pictures.

Encoded video markers can be inserted without having to decode or encode the encoded video stream (e.g., without having to re-encode the video stream with the inserted encoded video markers). For example, encoded video markers can be inserted as key frames (e.g., as I-frame or intra-coded frame). The encoded video markers can be inserted at particular locations in the encoded video stream, such as immediately before existing key frames (e.g., I-frames) in the encoded video stream. Such particular locations can be identified in the encoded video stream as sync locations (e.g., by only scanning the compressed bitstream, or by parsing the index information present in some container formats). For example, a sequence of sync locations can be identified in a video stream by identifying existing key frames occurring approximately every few seconds in the video stream.

Encoded video markers can be inserted as one or more key frames (e.g., I-frames) that do not have any dependent frames. Encoded video markers can be inserted with their own sequence parameter header and picture parameter header (e.g., as part of the meta-data of the encoded video frame).

Encoded audio markers can be inserted into encoded audio streams. For example, encoded audio markers can be inserted as new audio frames, or the encoded audio markers can be inserted by replacing existing audio frames.

Encoded audio markers can be inserted without having to decode or encode the encoded audio stream (e.g., without having to re-encode the audio stream with the inserted encoded audio markers). For example, encoded audio markers can be inserted as new audio frames between existing audio frames or by replacing existing audio frames.

By not having to decode or encode (e.g., re-encode or transcode) the encoded video and audio streams, encoded markers can be efficiently inserted. For example, encoded audio and video streams can be received from a variety of sources (e.g., files, network streams, live capture and encoding, etc.) and encoded marker frames can be inserted.

In addition, inserting encoded markers into encoded audio and video streams can provide for testing playback systems (e.g., various computing devices, various types of software and/or hardware, etc.). For example, inserting encoded markers into encoded streams can allow isolated testing of the playback path (e.g., the end-to-end playback path) without being affected by encoding processes (e.g., compared to inserting uncompressed markers into uncompressed audio-video content and then encoding the audio-video content with the inserted markers). In addition, inserting encoded markers into encoded audio and video streams can be used for testing audio-video synchronization when access to the original encoder(s) that were used to encode the audio-video content is not available (e.g., which could make it difficult to decode the encoded audio and video streams to insert uncompressed markers).

Encoded audio and video markers can be inserted at particular locations (e.g., sync locations) in the encoded audio and video streams. A sync location can be determined to be a location in an encoded audio stream and an encoded video stream with the same timestamp (e.g., at the same time position as indicated by a timestamp or time code) or nearly the same timestamp (e.g., the closest time position, such as within a few milliseconds). In some implementations, a sync location is determined by locating a key frame in a video stream (e.g., a key frame at a specific timestamp or time code). A corresponding location in an encoded audio stream is then determined (e.g., an audio frame at the same timestamp, or the closest timestamp, as the timestamp of the key frame in the video stream).

Encoded audio and video markers can be inserted at a number of sync locations. For example, a number of sync locations can be selected according to an interval (e.g., a user-selected or system defined interval, such as a number of seconds or minutes). For example, corresponding audio and video markers can be inserted approximately every 10 seconds into the encoded audio and video streams.

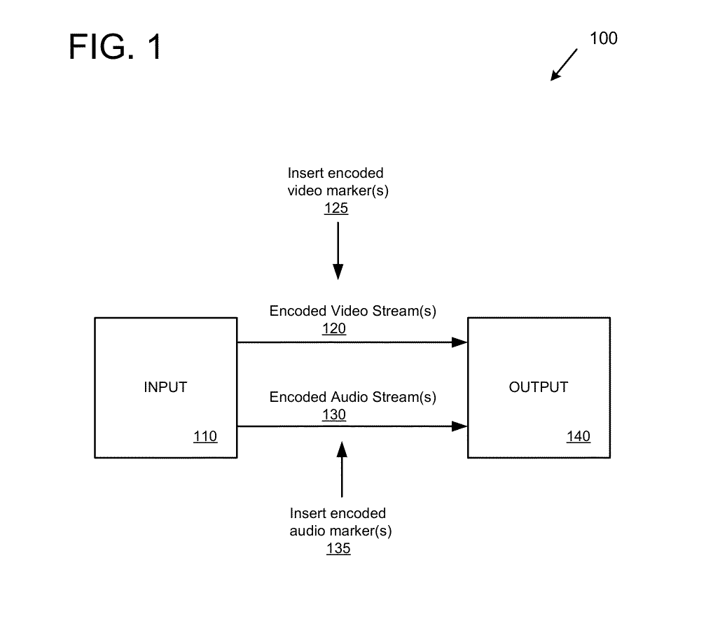

FIG. 1 is an example block diagram 100 depicting insertion of encoded audio-video markers into encoded audio-video streams. In the example diagram 100, encoded audio-video content is input 110. For example, the encoded audio-video content can be input via a file, a network connection, a live encoded stream, or via another source of encoded audio-video content.

Encoded video markers 125 are inserted into one or more encoded video streams 120. For example, the encoded video markers 125 can be inserted at one or more sync locations (e.g., on a periodic basis, such as every minute).

Encoded audio markers 135 are inserted into one or more encoded audio streams 130. For example, the encoded audio markers 135 can be inserted at one or more sync locations corresponding to the inserted encoded video markers 125.

The encoded video markers 125 and encoded audio markers 135 can be inserted at the same time (e.g., at the same, or nearly the same, timestamp location in the encoded video streams 120 and the encoded audio streams 130).

Once the encoded video markers and encoded audio markers have been inserted, the encoded video streams 120 and encoded audio streams 130 are output 140 (e.g., as test audio and video streams). For example, the encoded video streams 120 with the inserted encoded video markers 125 and the encoded audio streams 130 with the inserted encoded audio markers 135 can be output as one or more files (e.g., in a digital container format), as streaming audio-video content, directly to a decoder for audio-video playback and testing, to a remote device such as a television for playback and testing, etc. The output encoded audio-video content with the inserted markers can be played back to test audio-video synchronization (e.g., end-to-end synchronization testing of the playback path).

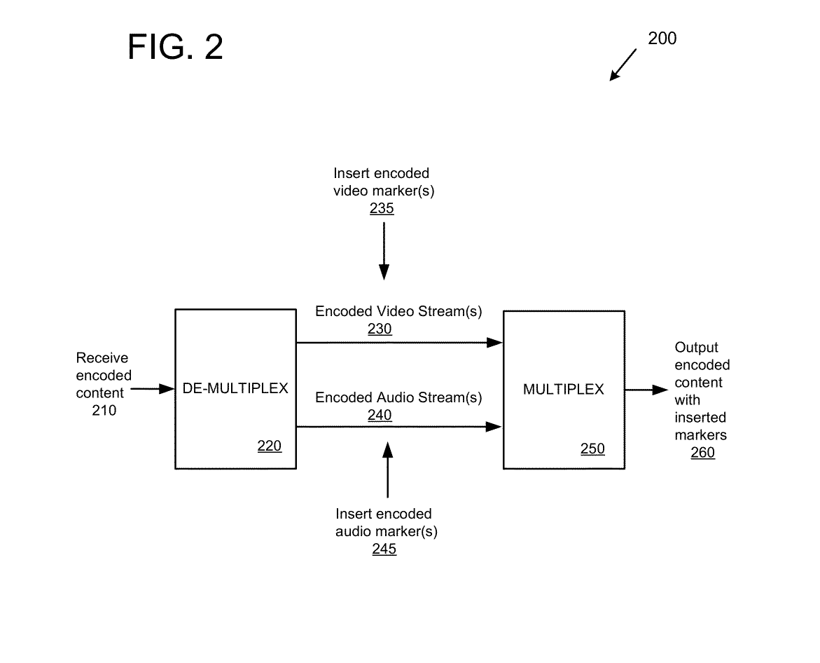

FIG. 2 is an example block diagram 200 depicting insertion of encoded audio-video markers into encoded audio-video streams, including de-multiplexing and multiplexing audio-video content. In the example diagram 200, encoded audio-video content is received at 210. For example, the encoded audio-video content can be received via a file, a network connection, a live encoded stream, or via another source of encoded audio-video content.

The received encoded audio-video content is de-multiplexed 220 to separate the one or more encoded video streams 230 and the one or more encoded audio streams 240. In some implementations, encoded audio-video content can comprise multiple video and/or multiple audio streams. In some implementations, only one encoded video stream and only one encoded audio stream are needed for inserting the encoded markers (e.g., only the encoded video stream and the encoded audio stream that will be used for playback and testing) even if multiple audio and/or video streams are present.

In some implementations, the received encoded audio-video content 210 may not need to be de-multiplexed 220. For example, the encoded audio-video content may be received as separate streams and therefore not require de-multiplexing in order to separate the audio from the video streams.

Encoded video markers 235 are then inserted into one or more encoded video streams 230. For example, the encoded video markers 235 can be inserted at one or more sync locations (e.g., on a periodic basis, such as every 10 seconds or every minute). Encoded audio markers 245 are inserted into one or more encoded audio streams 240. For example, the encoded audio markers 245 can be inserted at one or more sync locations corresponding to the inserted encoded video markers 235.

Once the encoded video markers and encoded audio markers have been inserted, the encoded video stream 230 and the encoded audio streams 240 are multiplexed 250 (re-multiplexed) to create encoded audio-video content with the inserted markers. For example, the encoded streams can be multiplexed 250 to create audio-video content in a digital container format, such as an AVI format file or stream.

The multiplexed audio-video content is then output 260. For example, the multiplexed audio-video content with the inserted markers can be saved to a file, streamed via a network connection, provided for playback (e.g., via local or remote audio and video components).

### Example 6

### Methods for Inserting Encoded Markers

In any of the examples herein, methods can be provided for inserting encoded audio and video markers into encoded audio and video streams. The markers can be inserted without changing the overall duration (length) of the encoded audio and video streams. The markers can be inserted without having to decode or encode (or re-encode) the encoded audio and video streams.

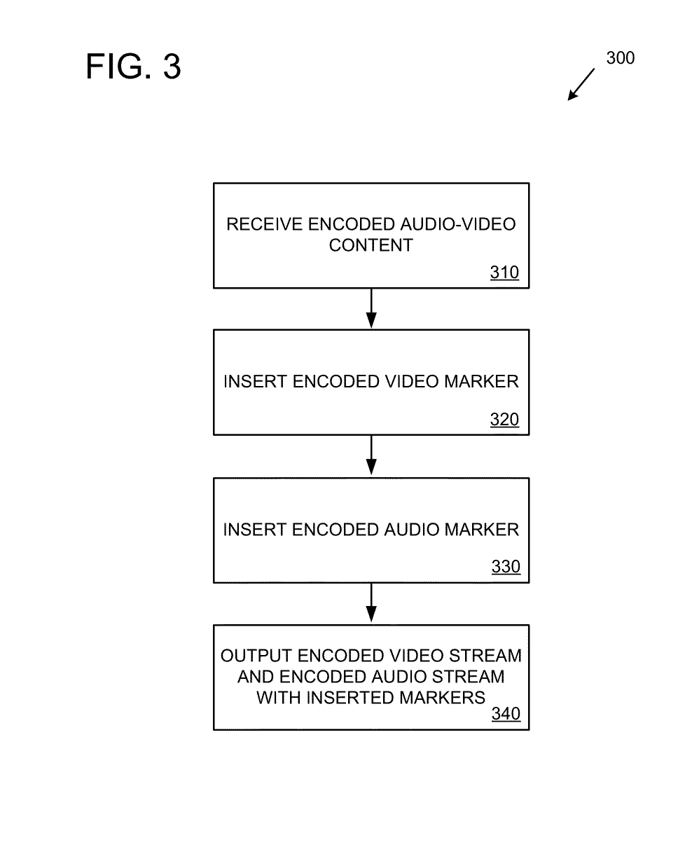

FIG. 3 is a flowchart of an example method 300 for inserting encoded markers into encoded audio-video content. The example method 300 can be performed, at least in part, by a computing device.

At 310, encoded audio-video content comprising an encoded video stream and an encoded audio stream is received. For example, the encoded audio-video content can be received from a file, from a network connection (e.g., as streaming encoded audio-video content), or from another source. The encoded audio-video content can be de-multiplexed to separate the encoded audio stream and the encoded video stream. Alternatively, the encoded audio-video content can be received as separate encoded streams.

At 320, an encoded video marker is inserted into the encoded video stream. The encoded video marker can be inserted at a video sync location (e.g., at an existing video key frame located at a particular video timestamp). The encoded video marker can be inserted without decoding or encoding the encoded video stream. The encoded video marker can be inserted without affecting the overall duration of the encoded video stream (e.g., while maintaining the same duration or length of the encoded video stream before and after the insertion).

At 330, an encoded audio marker is inserted into the encoded audio stream. The encoded audio marker can be inserted at an audio sync location (e.g., at an existing audio frame, or set of frames, located at a particular audio timestamp) corresponding to the video sync location (e.g., at the same timestamp location, or the closest audio frame to the timestamp location). The encoded audio marker can be inserted without decoding or encoding the encoded audio stream. The encoded audio marker can be inserted without affecting the overall duration of the encoded audio stream (e.g., while maintaining the same duration of the encoded audio stream before and after the insertion).

At 340, the encoded video stream and the encoded audio stream with the inserted markers is output. For example, the encoded streams can be output to a file (e.g., in a digital container format), to a network connection, for playback on audio-video components (e.g., a display and speakers), etc.

The example method 300 can be used to insert encoded video markers and encoded audio markers into multiple encoded audio streams and/or multiple encoded video streams. In addition, the example method 300 can be used to insert corresponding encoded video and audio markers at multiple sync locations (e.g., on a periodic basis, such as every 10 seconds or every minute within the encoded audio and video streams).

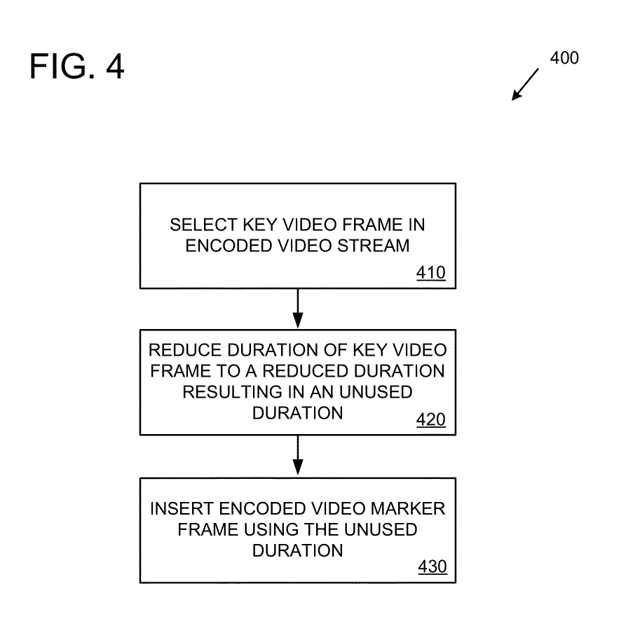

FIG. 4 is a flowchart of an example method 400 for inserting encoded video markers while maintaining the same overall duration. The example method 400 can be performed, at least in part, by a computing device.

At 410, a key video frame (e.g., an I-frame or intra-coded frame) is selected in an encoded video stream. The key frame can be selected based on various criteria. For example, the key frame can be selected based on a frequency with which markers are to be inserted (e.g., every 10 seconds, every 5 minutes, etc.). The key frame can also be selected based on a comparison of timing information between the encoded video stream and an associated encoded audio stream. For example, a key video frame can be selected that has a timestamp corresponding to a timestamp of an audio frame in the encoded audio stream (e.g., where the key video frame and the audio frame have the same timestamp, or nearly the same timestamp, such as within a few milliseconds of each other).

At 420, the duration of the key video frame is reduced resulting in an unused duration. For example, for 30 FPS (frames-per-second) video content, each frame is displayed for 1/30^{th} of a second (approximately 33 milliseconds). If the key video frame selected at 410 is encoded within 30 FPS video content, then the duration of the key video frame can be reduced in duration by half, to 1/60^{th} of a second (approximately 16 milliseconds). After the reduction, there will be an unused duration that was previously used by the key video frame. In this example, the unused duration will be 1/60^{th} of a second (approximately 16 milliseconds).

In some implementations, the duration of the existing key video frame is reduced at 420 by half (e.g., from 1/30^{th} of a second to 1/60^{th} of a second). Alternatively, the duration of the existing key video frame can be reduced by more or less than one-half.

At 430, an encoded video marker frame is inserted into the encoded video stream using the unused duration. For example, if the key video frame is reduced from 1/30^{th} of a second in duration to 1/60^{th} of a second in duration, then the inserted encoded video marker frame can use the unused 1/60^{th} of a second.

In some implementations, the example method 400 is performed, in part, by updating meta-data associated with the encoded video stream, such as a meta-data table indicating timing information (e.g., a timestamp table or index table). Such meta-data can specify the timing of the video pictures (e.g., video frames and/or video fields). By modifying the meta-data, the existing key video frame duration can be set to the reduced duration (e.g., at 420) and the inserted encoded video marker can be set to use the unused duration (e.g., at 430).

In some implementations, the reduction in duration of the existing key video frame at 420, and thus the unused duration, is determined so that the inserted encoded marker frame will be displayed when the encoded stream is played back. For example, if a display (e.g., a built-in mobile device display, external computer display, or another type of display) displays video content at 60 Hz, then a video frame may need to be at least 1/60^{th} of a second in duration in order to be displayed. In this situation, the existing key video frame can be reduced in duration to leave at least 1/60^{th} of a second in unused duration for the inserted encoded video frame. Depending on the display rate (e.g., 30 Hz, 60 Hz, 120 Hz, etc.) of the display on which the encoded stream will be played back, the duration of the inserted encoded video frame may need to be adjusted, and in some situations (e.g., where the display rate is less than the video frame rate) multiple encoded video frames may need to be inserted in order to ensure that the marker is displayed.

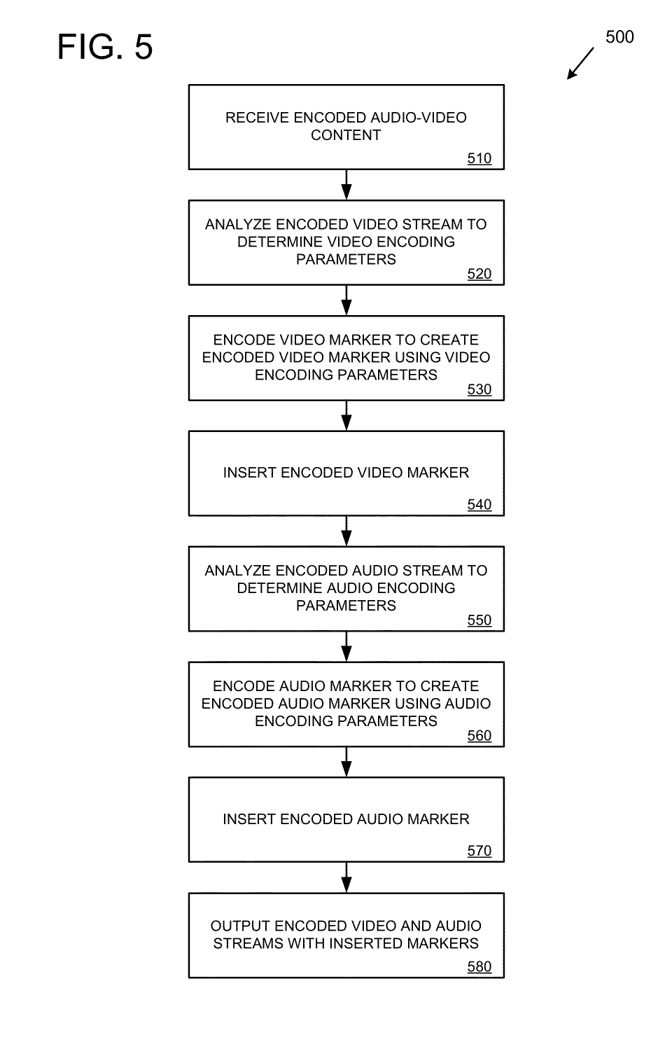

FIG. 5 is a flowchart of an example method 500 for creating encoded audio-video markers based on audio-video encoding parameters. The example method 500 can be performed, at least in part, by a computing device.

At 510, encoded audio-video content comprising an encoded video stream and an encoded audio stream is received. For example, the encoded audio-video content can be received from a file, from a network connection (e.g., as streaming encoded audio-video content), or from another source. The encoded audio-video content can be de-multiplexed to separate the encoded audio stream and the encoded video stream. Alternatively, the encoded audio-video content can be received as separate encoded streams.

At 520, the encoded video stream received with the encoded audio-video content 510 is analyzed to determine video encoding parameters. The video encoding parameters indicate how the video stream was encoded (e.g., the codec and associated video coding standard used, resolution, frame rate, and/or other codec-specific encoding parameters and options).

At 530, a video marker (e.g., comprising one or more video frames and/or fields) is encoded based, at least in part, on the determined video encoding parameters 520 to create an encoded video marker. For example, all, or most, of the determined video encoding parameters 520 can be used to create the encoded video marker. Using the determined video encoding parameters 520, the video marker can be encoded in a manner that is compatible with the encoded video stream (e.g., that will display properly when the encoded video stream is played back).

At 540, the encoded video marker that was created at 530 is inserted into the encoded video stream. The encoded video marker can be inserted at a video sync location (e.g., a particular video timestamp). The encoded video marker can be inserted without decoding or encoding the encoded video stream. The encoded video marker can be inserted without affecting the overall duration of the encoded video stream (e.g., while maintaining the same duration of the encoded video stream before and after the insertion).

At 550, the encoded audio stream received with the encoded audio-video content 510 is analyzed to determine audio encoding parameters. The audio encoding parameters indicate how the audio stream was encoded (e.g., the codec and associated audio coding standard used, bit rate, sampling rate, channel information, and/or other codec-specific encoding parameters and options).

At 560, an audio marker (e.g., comprising one or more audio frames) is encoded based, at least in part, on the determined audio encoding parameters 550 to create an encoded audio marker. For example, all, or most, of the determined audio encoding parameters 550 can be used to create the encoded audio marker. Using the determined audio encoding parameters 550, the audio marker can be encoded in a manner that is compatible with the encoded audio stream (e.g., that plays properly when the encoded audio stream is played back).

At 570, the encoded audio marker that was created at 560 is inserted into the encoded audio stream. The encoded audio marker can be inserted at an audio sync location (e.g., a particular audio timestamp) corresponding to the video sync location (e.g., at the same, or nearly the same, timestamp location in both the encoded video stream and the encoded audio stream). The encoded audio marker can be inserted without decoding or encoding the encoded audio stream. The encoded audio marker can be inserted without affecting the overall duration of the encoded audio stream (e.g., while maintaining the same duration of the encoded audio stream before and after the insertion).

At 580, the encoded video stream and the encoded audio stream with the inserted markers is output. For example, the encoded streams can be output to a file (e.g., in a digital container format), to a network connection, for playback on audio-video components (e.g., a display and speakers), etc.

### Example 7

### Example Implementations for Inserting Encoded Markers

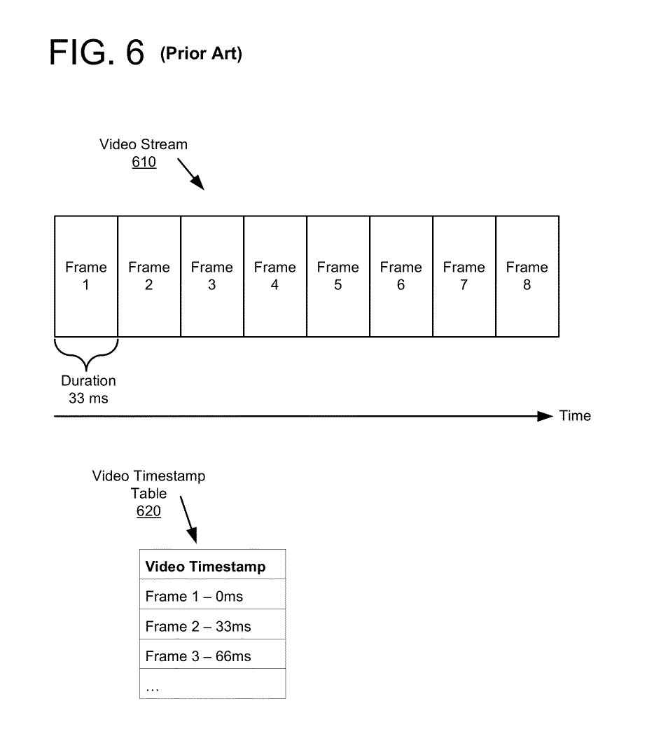

FIG. 6 depicts a prior art diagram of an example video stream 610 and corresponding video timestamp table 620. The example video stream 610 is encoded at 30 FPS. Therefore, each frame has a duration of 1/30^{th} of a second (approximately 33 milliseconds).

The video stream 610 depicts a number of video frames. Specifically, eight video frames are depicted. For example, Frame 1 could be a key frame (e.g., an I-frame), frames 2-7 could be predicted frames (e.g., P-frames) that are predicted from Frame 1, and Frame 8 could be another key frame.

The video timestamp table 620 indicates the time at which each frame is displayed, which also indicates the duration of display for each frame. As depicted in the video timestamp table 620, Frame 1 is displayed at 0 milliseconds (ms), Frame 2 is displayed at 33 ms, Frame 3 is displayed at 66 ms, and so on. Each of the frames depicted in the video stream 610 is displayed for a duration of approximately 33 ms.

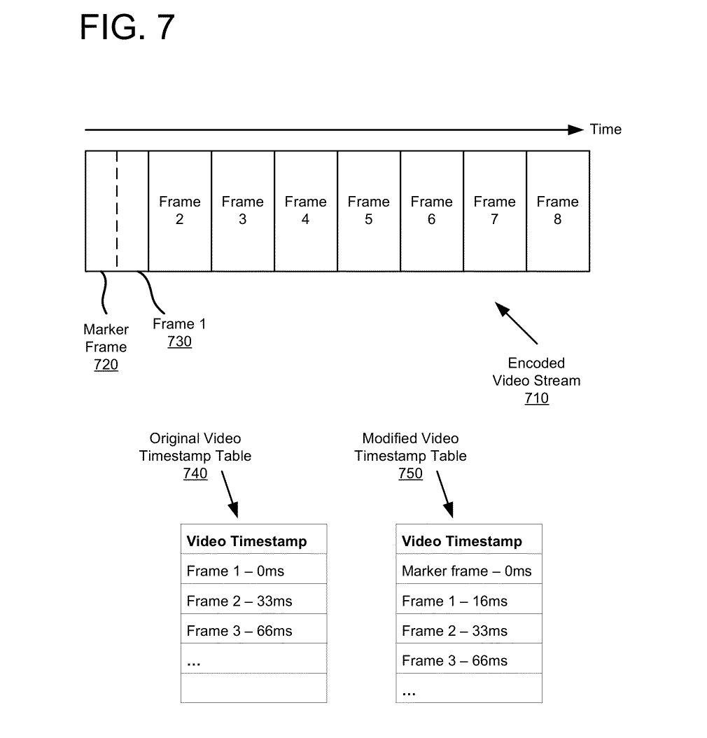

FIG. 7 is a diagram depicting an example encoded video stream 710 and corresponding video timestamp table showing an inserted encoded video marker frame. FIG. 7 illustrates an example implementation where a marker video frame is inserted into the encoded video stream 710 without changing the overall duration.

The encoded video stream depicted at 710 comprises eight video frames. In order to insert an encoded video marker into the encoded video stream 710 while maintaining the same overall duration of the encoded video stream 710, the duration of Frame 1 (730) has been reduced. Specifically, in this example, the duration of Frame 1 (730) has been reduced by half, from 1/30^{th} of a second to 1/60^{th} of a second (from approximately 33 ms to approximately 16 ms). The reduction in duration is depicted graphically in FIG. 7 as Frame 1 (730) now occupies the right-hand portion (to the right of the dashed line) of the original first frame duration.

Using the unused duration, an encoded video marker frame 720 is inserted into the encoded video stream 710. In this example, the duration of the encoded video marker frame 720 is inserted using the remaining 1/60^{th} of a second left unused by the reduction in duration of existing Frame 1 (730). The inserted encoded video marker frame 720 is depicted graphically in FIG. 7 as occupying the left-hand portion (to the left of the dashed line) of the original first frame duration.

In some implementations, inserting an encoded video marker involves modifying a timestamp table (or other meta-data associated with the encoded video stream) in order to specify display times, durations, and/or other timing information. In FIG. 7, an original timestamp table 740 is depicted. As indicated by the original timestamp table 740, the encoded video stream 710 is encoded at a rate of 30 FPS, so each frame is 1/30^{th} of a second in duration (approximately 33 ms). When Frame 1 (730) is reduced in duration and the encoded video marker frame 720 is inserted, the original timestamp table 740 is modified as depicted in the modified timestamp table 750. As indicated by the modified timestamp table 750, the encoded video marker frame 720 is displayed first (at 0 ms in this example) for a duration of 1/60^{th} of a second (approximately 16 ms), followed by Frame 1 (730), which is displayed next at 16 ms for a duration of 1/60^{th} of a second, followed by Frame 2, which is displayed next at 33 ms for a duration of 1/30^{th} of a second, and so on. In this manner, the encoded video marker frame 720 and Frame 1 (730) take up the duration previously occupied by Frame 1 (730), and the overall duration of the encoded video stream 710 remains the same. Furthermore, as depicted in the modified timestamp table 750, only the timing information for the marker frame and the frame being reduced in duration need to be modified; the timing information for remaining frames in the video stream remain unchanged.

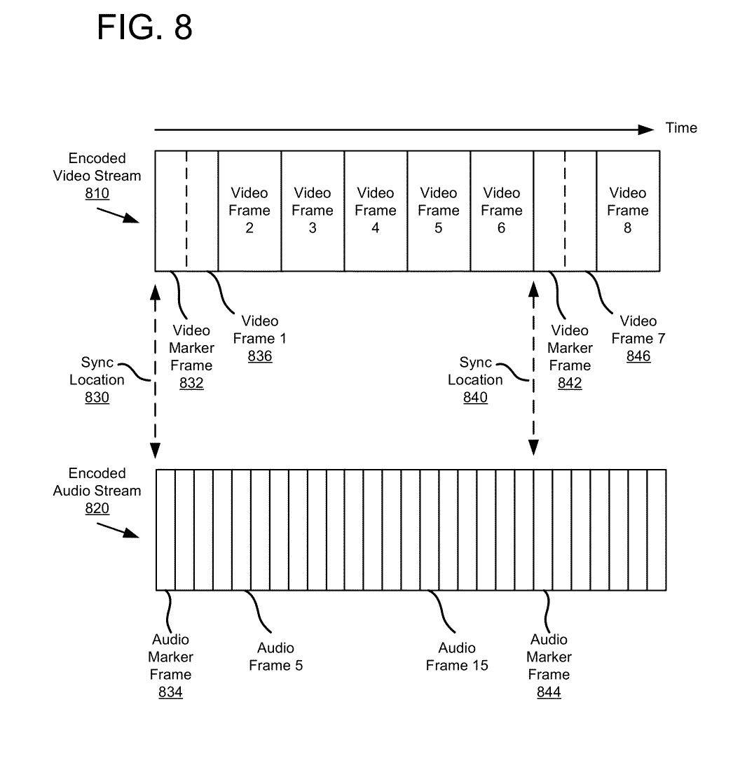

FIG. 8 is a diagram showing example video and audio streams with inserted video and audio markers at sync locations. FIG. 8 illustrates an example implementation where marker frames are inserted at sync locations into encoded video and audio streams without changing the overall duration of the streams.

In FIG. 8, an example encoded video stream 810 is depicted. The example encoded video stream 810 is encoded at a rate of 30 FPS, and each video frame has an original duration of 1/30^{th} of a second. An example encoded audio stream 820 is also depicted. The example encoded audio stream 820 is encoded using audio frames with a duration of 10 ms each.

In order to insert audio-video markers into the encoded video stream 810 and the encoded audio stream 820, sync locations are determined at corresponding locations in the two streams. Specifically, in this example, two sync locations have been determined, sync location 830 and sync location 840. For example, if both the encoded video stream 810 and the encoded audio stream 820 start at time 0 ms, then the first sync location 830 will be at the same timestamp location (0 ms) in both streams, and the second sync location 840 will also be at the same timestamp location (200 ms) in both streams.

After the sync locations have been determined, encoded markers are inserted. Specifically, in this example, an encoded video marker frame 832 and an encoded audio marker frame 834 have been inserted at the first sync location 830 in both the encoded video stream 810 and the encoded audio stream 820. The encoded video marker frame 832 has been inserted using unused duration resulting from reduction in duration of existing video frame 1 (836). The encoded audio marker frame 834 has been inserted by replacing the original audio frame at the sync location 830. Another encoded video marker frame 842 and corresponding audio marker frame 844 have been inserted at the second sync location 840 in both the encoded video stream 810 and the encoded audio stream 820. Once again, the encoded video marker frame 842 has been inserted using unused duration resulting from reduction in duration of existing video frame 7 (846). The encoded audio marker frame 844 has been inserted by replacing the original audio frame at the sync location 840.

In some implementations, the encoded audio marker uses a duration at least as long as the encoded video marker. For example, using the example depicted in FIG. 8, if the video marker frame 832 is 1/30^{th} of a second in duration (approximately 16 ms), then the corresponding encoded audio marker can take up two audio frames (20 ms total), instead of the single audio frame as depicted at 834.

### Example 8

### Testing Audio-Video Synchronization

In the examples herein, techniques are provided for testing audio-video synchronization using encoded audio and video markers inserted into encoded audio and video streams. Audio-video synchronization testing can be performed by obtaining encoded audio-video content and inserting encoded markers without having to decode or encode the encoded audio-video content. The encoded audio-video content with the inserted markers can be played back and the decoded audio-video content can be captured. For example, the decoded audio-video content can be captured with reduced quality (e.g., reduced resolution for video and reduced channels/quality for audio), which can reduce capture overhead and optimize capture performance (e.g., reduce capture latency). Corresponding markers can be detected and matched in the captured decoded audio-video content and audio-video synchronization information can be output.

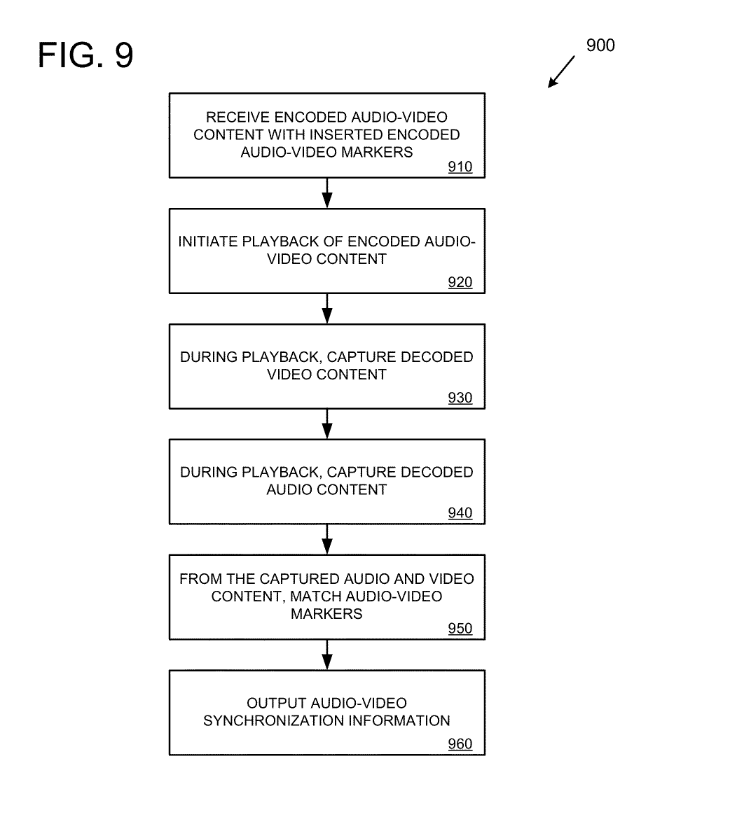

FIG. 9 is a flowchart of an example method 900 for testing synchronization of encoded audio-video content with inserted encoded audio-video markers. The example method 900 can be performed, at least in part, by a computing device.

At 910, encoded audio-video content is received with inserted encoded audio-video markers. The encoded audio-video content comprises an encoded video stream with one or more inserted encoded video markers and an encoded audio stream with one or more corresponding inserted encoded audio markers.

At 920, playback of the encoded audio-video content is initiated. For example, playback can be initiated by providing the encoded audio-video content to operating system components (e.g., media player components), or other software and/or hardware, of a computing device.

At 930, decoded video content is captured during playback. The decoded video content can be captured as it would be displayed on a display (e.g., computer monitor or integrated mobile device display). For example, the decoded video content can be captured via a software application programming interface (API) that provides access to decoded video content prior to, or contemporaneous with, display (e.g., that captures decoded video at the video endpoint). For example, a software-based solution can capture decoded video content using screen scraping. In a specific implementation, the decoded video content is captured as uncompressed YUV raw video. The decoded video content can also be captured from the display by a separate device, such as via an external video camera or an HDMI capture device. The decoded video content can be captured with associated video playback timing information (e.g., high precision timing information) indicating the time at which pictures are displayed (e.g., just for video marker content or for additional video content as well.).

In some implementations, the decoded video content that is captured during playback 930 is captured at a reduced resolution. Capturing the decoded video content at a reduced resolution can be more efficient (e.g., in terms of latency and computing resources) than capturing the decoded video content at the original resolution. Encoded video markers can be recognized even if captured at a reduced resolution. For example, a video marker that is a black frame (e.g., in a video stream that does not contain a black frame) can be recognized at full resolution or at a reduced resolution.

At 940, decoded audio content is captured during playback. The decoded audio content can be captured as it would be played on a speaker (e.g., a built-in speaker, external speakers, headphones, etc.). For example, the decoded audio content can be captured via a software application programming interface (API) that provides access to decoded audio content prior to, or contemporaneous with, playback (e.g., that captures decoded audio at the audio endpoint). For example, decoded audio can be captured using a software-based solution that uses a loop back capture feature available from the operating system. In a specific implementation, the decoded audio content is captured as uncompressed PCM raw audio. The decoded audio content can also be captured by a separate device, such as via an external microphone. The decoded audio content can be captured with associated audio playback timing information (e.g., high precision timing information) indicating the time at which audio content is played (e.g., just for audio marker content or for additional audio content as well).

In some implementations, the decoded audio content that is captured during playback 940 is captured with a reduced number of audio channels and/or with reduced quality (e.g., with a reduced bit depth and/or sampling rate). For example, decoded audio content with 2-channel stereo audio can be captured as a single channel (e.g., by selecting one of the two channels for capture) and/or at a reduced bit depth (e.g., 8-bit audio) or sampling rate (e.g., 22 kHz). Capturing the decoded audio content with reduced channels (e.g., a single channel) and/or with reduced quality can be more efficient (e.g., in terms of latency and computing resources) than capturing the decoded audio content with higher quality (e.g., corresponding to the quality of the encoded audio stream). Encoded audio markers can be recognized even if captured with reduced channels and/or reduced quality. For example, a specific audio tone marker that is present in all channels (e.g., in an audio stream that does not otherwise contain such a tone) can be recognized even if only one channel is captured and/or if capture quality is reduced.

In a specific implementation, playback, decoding, and capture (e.g., at 920, 930, and 940) is performed using, at least in part, Microsoft® Media Foundation APIs.

At 950, matching audio and video markers are detected in the captured decoded video content (from 930) and the captured decoded audio content (from 940). Matching corresponding pairs of audio and video markers can be performed, for example, by matching the first pair of audio and video markers, the second pair of audio and video markers, and so on. Corresponding audio and video markers can also be matched by examining the content of the marker. For example, video markers can comprise an identifier (e.g., a sequence number or timestamp) which can be matched to a corresponding audio marker that comprises specific audio content (e.g., a specific tone, sequence of tones, or other recognizable audio pattern) that has been pre-determined to correspond to the video marker identifier.

In some implementations, the matching 950 is performed in real-time or near real-time as the decoded video and audio is captured (at 930 and 940). In other implementations, the decoded video and audio is captured (at 930 and 940) and saved for later analysis (e.g., for matching, as described with regard to 950).

At 960, audio-video synchronization information is output based on the matching performed at 950. For example, the synchronization information can comprise indications of differences between corresponding audio and video markers detected in the decoded audio-video content (e.g., based on associated audio-video playback timing information). For example, if an encoded video marker and corresponding encoded audio marker were inserted at the same timestamp (e.g., at 5 minutes, 10 seconds, 100 ms timestamp in both the encoded video stream and the encoded audio stream), then the difference detected between playback of the markers can be output (e.g., if the video marker is played back beginning at time t1 and the audio marker is played back beginning at time t1+115 ms, then information indicating that audio synchronization is off by 115 ms at the location of the video and audio markers can be output). Audio-video synchronization information can also indicate whether synchronization difference between corresponding audio and video markers is within a threshold value (e.g., within a pre-set or user-configured threshold, such as within 20 ms) or not.

In a specific implementation, corresponding audio and video markers present in captured decoded audio and video streams (e.g., as described at 930 and 940) are matched and their presentation times (display times) are recorded. Audio-video synchronization issues can then be reported. For example, synchronization issues can be reported if the presentation times for the corresponding markers are not within a threshold value (e.g., a pre-determined or user-configured threshold that indicates an allowable gap or offset in milliseconds).

In the specific implementation, the auto-correlation of an audio marker is computed using the following equation (Equation 1):

CorrM=Σₖ₌₀^{N-1}(M[k]×M[k]) (Equation 1)

In Equation 1, N is the length of the audio marker, M[k]. Then cross-correlation between the audio marker M[k] and the captured audio stream T[i+k] at position i in the captured sequence is computed using the following equation (Equation 2):

CorrTᵢ=Σₖ₌₀^{N-1}(T[i+k]×M[k]) (Equation 2)

If CorrM×α>CorrTᵢ>CorrM×β, where α and β can be chosen as 1.1 and 0.9, respectively, in the specific implementation, the audio marker is detected at sample position i in the captured audio stream

In the specific implementation, the video marker is detected using the following equation (Equation 3):

γ_{c1}<P_{c}(x,y)<γ_{c2} Equation 3)

Using Equation 3, the video marker is detected for any position (x, y) in the captured frame, where P_{c}(x, y) is the pixel value at the spatial position of (x, y) inside the luma (Y) component or the chroma (U or V) component of the frame. In the specific implementation γ_{c1} and γ_{c2} are set to 0 and 16, respectively, for Y, and 120 and 136, respectively, for U and V.

In other implementations, other detection techniques can be employed to detect audio and video markers in captured decoded audio and video content.

### Example 9

### Computing Systems

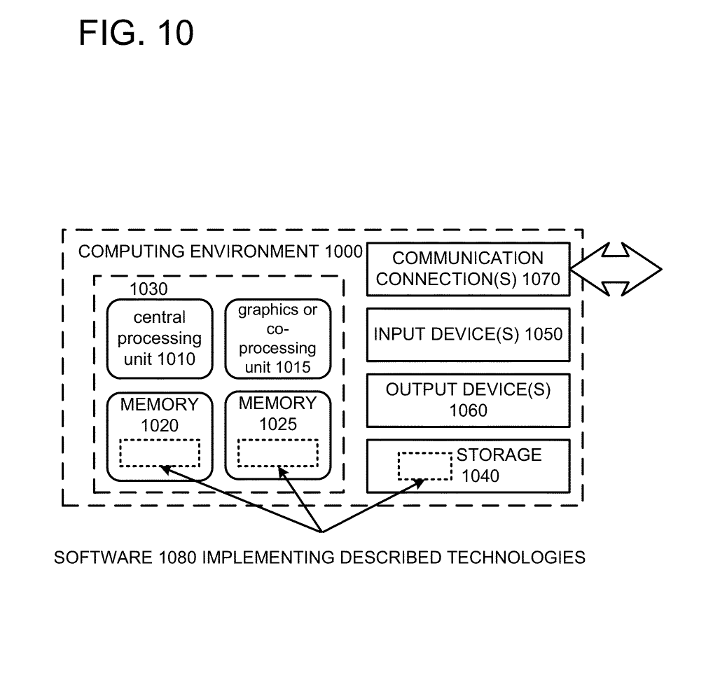

FIG. 10 depicts a generalized example of a suitable computing system 1000 in which the described innovations may be implemented. The computing system 1000 is not intended to suggest any limitation as to scope of use or functionality, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 10

### Mobile Device

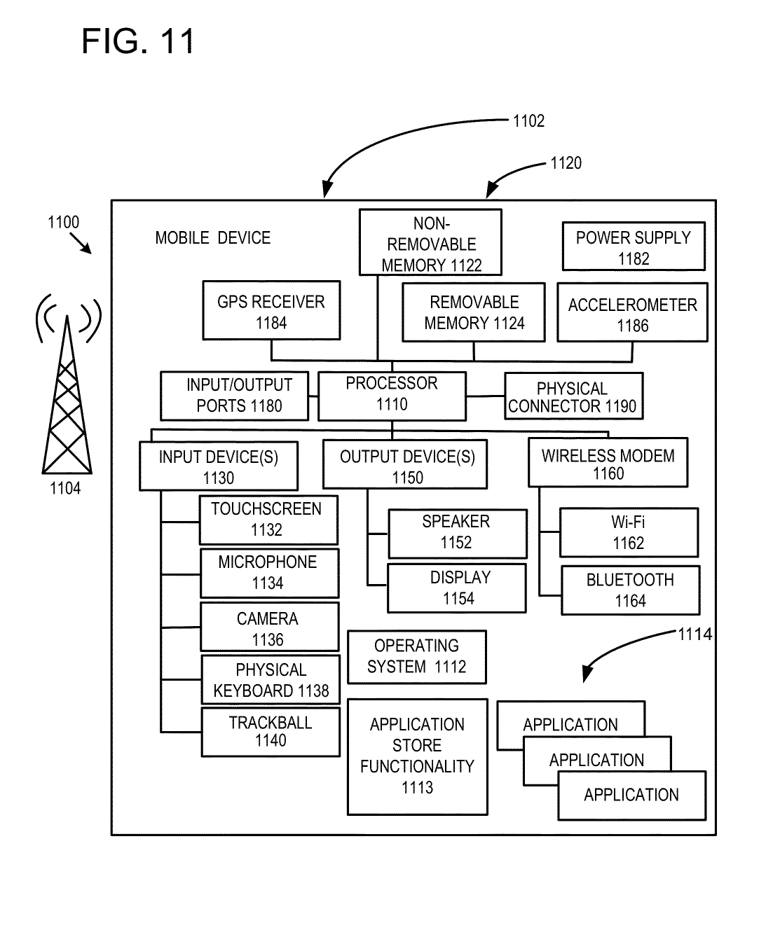

FIG. 11 is a system diagram depicting an exemplary mobile device 1100 including a variety of optional hardware and software components, shown generally at 1102. Any components 1102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application. Functionality 1113 for accessing an application store can also be used for acquiring and updating application programs 1114.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140 and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands. Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

### Example 11

### Cloud-Supported Environment

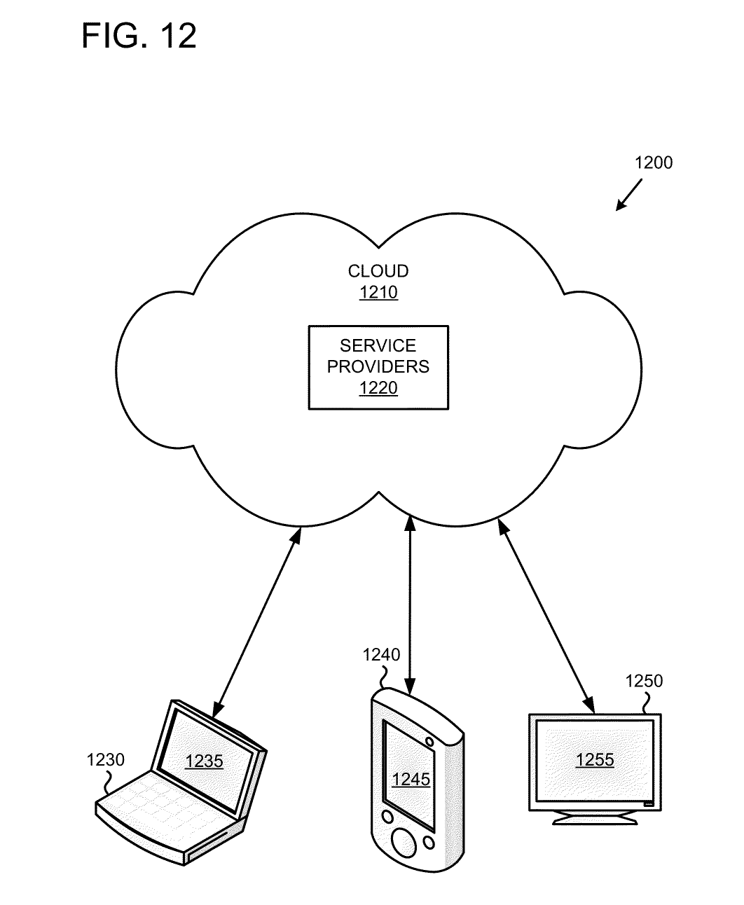

FIG. 12 illustrates a generalized example of a suitable implementation environment 1200 in which described embodiments, techniques, and technologies may be implemented. In the example environment 1200, various types of services (e.g., computing services) are provided by a cloud 1210. For example, the cloud 1210 can comprise a collection of computing devices, which may be located centrally or distributed, that provide cloud-based services to various types of users and devices connected via a network such as the Internet. The implementation environment 1200 can be used in different ways to accomplish computing tasks. For example, some tasks (e.g., processing user input and presenting a user interface) can be performed on local computing devices (e.g., connected devices 1230, 1240, 1250) while other tasks (e.g., storage of data to be used in subsequent processing) can be performed in the cloud 1210.

In example environment 1200, the cloud 1210 provides services for connected devices 1230, 1240, 1250 with a variety of screen capabilities. Connected device 1230 represents a device with a computer screen 1235 (e.g., a mid-size screen). For example, connected device 1230 could be a personal computer such as desktop computer, laptop, notebook, netbook, or the like. Connected device 1240 represents a device with a mobile device screen 1245 (e.g., a small size screen). For example, connected device 1240 could be a mobile phone, smart phone, personal digital assistant, tablet computer, and the like. Connected device 1250 represents a device with a large screen 1255. For example, connected device 1250 could be a television screen (e.g., a smart television) or another device connected to a television (e.g., a set-top box or gaming console) or the like. One or more of the connected devices 1230, 1240, 1250 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1200. For example, the cloud 1210 can provide services for one or more computers (e.g., server computers) without displays.

Services can be provided by the cloud 1210 through service providers 1220, or through other providers of online services (not depicted). For example, cloud services can be customized to the screen size, display capability, and/or touchscreen capability of a particular connected device (e.g., connected devices 1230, 1240, 1250).

In example environment 1200, the cloud 1210 provides the technologies and solutions described herein to the various connected devices 1230, 1240, 1250 using, at least in part, the service providers 1220. For example, the service providers 1220 can provide a centralized solution for various cloud-based services. The service providers 1220 can manage service subscriptions for users and/or devices (e.g., for the connected devices 1230, 1240, 1250 and/or their respective users).

### Example 12

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 10, computer-readable storage media include memory 1020 and 1025, and storage 1040. By way of example and with reference to FIG. 11, computer-readable storage media include memory and storage 1120, 1122, and 1124. The term computer-readable storage media does not include signals and carrier waves. In addition, the term computer-readable storage media does not include communication connections (e.g., 1070, 1160, 1162, and 1164).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for inserting encoded markers into encoded audio-video content, the method comprising:
receiving, by the computing device, encoded audio-video content comprising an encoded video stream and an encoded audio stream;
inserting, by the computing device, an encoded video marker into the encoded video stream at a video sync location, wherein the encoded video marker is inserted without decoding or re-encoding the encoded video stream;
inserting, by the computing device, an encoded audio marker into the encoded audio stream at an audio sync location corresponding to the video sync location, wherein the encoded audio marker is inserted without decoding or re-encoding the encoded audio stream; and
outputting, by the computing device, the encoded video stream with the inserted encoded video marker and the encoded audio stream with the inserted encoded audio marker.

2. The method of claim 1 wherein the receiving comprises:
de-multiplexing the encoded audio-video content to produce the encoded video stream and the encoded audio stream.

3. The method of claim 1 wherein the outputting comprises:
re-multiplexing the encoded video stream with the inserted encoded video marker and the encoded audio stream with the inserted encoded audio marker.

4. The method of claim 1 further comprising:
analyzing the encoded video stream to determine video encoding parameters; and
encoding a video marker using, at least in part, the determined video encoding parameters to create the encoded video marker.

5. The method of claim 1 wherein overall duration of the encoded video stream remains the same after the encoded video marker is inserted, and wherein substantially all original properties of the encoded audio stream and the encoded video stream remain the same after the encoded audio and video streams are output.

6. The method of claim 5 wherein the encoded video marker is an encoded video marker frame, wherein inserting the encoded video marker frame comprises:
selecting an existing key video frame, wherein the existing key video frame is located at the video sync location;
reducing a duration of the existing key video frame, creating an unused duration; and
inserting the encoded video marker frame using the unused duration.

7. The method of claim 6 wherein the duration of the existing key video frame is reduced by half, and wherein the encoded video marker frame is inserted as a key video frame immediately before the existing key video frame using the unused duration.

8. The method of claim 5 further comprising:
modifying a meta-data table associated with the encoded video stream according to the reduced duration of the existing key video frame and the unused duration for the inserted encoded video marker frame.

9. The method of claim 1 wherein the encoded video marker frame is inserted with an associated sequence parameter header and an associated picture parameter header.

10. The method of claim 1 wherein the audio sync location is a closest timestamp location to the video sync location.

11. The method of claim 1 further comprising:
analyzing the encoded audio stream to determine audio encoding parameters; and
encoding an audio marker using, at least in part, the determined audio encoding parameters to create the encoded audio marker.

12. The method of claim 1 wherein inserting the encoded audio marker comprises:
replacing an existing audio frame in the encoded audio stream with an encoded audio marker frame.

13. The method of claim 1 further comprising:
inserting one or more additional encoded video markers and encoded audio markers at one or more additional video sync locations and corresponding audio sync locations, wherein the one or more additional encoded video markers and encoded audio markers are inserted without decoding, and without re-encoding, the encoded video and audio streams.

14. A computing device comprising:
a processing unit; and
memory;
the computing device configured to perform operations for inserting encoded markers into encoded audio-video content, the operations comprising:
receiving encoded audio-video content comprising an encoded video stream and an encoded audio stream;
analyzing the encoded video stream to determine video encoding parameters;
encoding a video marker using, at least in part, the determined video encoding parameters to create an encoded video marker compatible with the encoded video stream;
inserting the encoded video marker into the encoded video stream at a video sync location, wherein the encoded video marker is inserted without decoding or re-encoding the encoded video stream, and wherein overall duration of the encoded video stream remains the same after the encoded video marker is inserted;
analyzing the encoded audio stream to determine audio encoding parameters;
encoding an audio marker using, at least in part, the determined audio encoding parameters to create an encoded audio marker compatible with the encoded audio stream;
inserting the encoded audio marker into the encoded audio stream at an audio sync location corresponding to the video sync location, wherein the encoded audio marker is inserted without decoding or re-encoding the encoded audio stream; and
outputting the encoded video stream with the inserted encoded video marker and the encoded audio stream with the inserted encoded audio marker.

15. The computing device of claim 14 wherein the encoded video marker is an encoded video marker frame, wherein inserting the encoded video marker frame comprises:
selecting an existing key video frame, wherein the existing key video frame is located at the video sync location;
reducing a duration of the existing key video frame, creating an unused duration; and
inserting the encoded video marker frame using the unused duration.

16. The computing device of claim 15 wherein the duration of the existing key video frame is reduced by half, and wherein the encoded video marker frame is inserted as a key video frame immediately before the existing key video frame using the unused duration.

17. A computer-readable storage medium storing computer-executable instructions for testing synchronization of encoded audio-video content, the method comprising:
receiving encoded audio-video content comprising an encoded video stream and an encoded audio stream, the encoded video stream comprising one or more video markers, and the encoded audio stream comprising one or more corresponding audio markers;
initiating playback of the encoded audio-video content;
during playback of the encoded audio-video content:
capturing decoded video content, wherein the captured video content is captured at a reduced resolution; and
capturing decoded audio content, wherein the captured audio content is captured with a reduced number of audio channels;
from the captured video content and the captured audio content, matching the one or more video markers and the one or more corresponding audio markers; and
based on the matching, outputting audio-video synchronization information.

18. The computer-readable storage medium of claim 17 wherein outputting the audio-video synchronization information comprises:
outputting an indication of playback timing differences between the matched one or more video markers and the one or more corresponding audio markers.

19. The computer-readable storage medium of claim 17 wherein outputting the audio-video synchronization information comprises:
if timing differences between the matched one or more video markers and the one or more corresponding audio markers is above a pre-defined threshold value, outputting an indication of an audio-video synchronization problem.

20. The computer-readable storage medium of claim 17 wherein the captured audio content is captured with reduced audio quality.
